(19) United States
(12) Patent Application Publication
(10) Pub. No.: US 2025/0329849 A1
(43) Pub. Date: Oct. 23, 2025

(54) ELECTRICITY STORAGE APPARATUS

(71) Applicant: TOYOTA JIDOSHA KABUSHIKI KAISHA, Toyota-shi (JP)

(72) Inventors: Shingo AIJIMA, Shizuoka-ken (JP); Shigeyuki INOUE, Toyota-shi (JP)

(73) Assignee: TOYOTA JIDOSHA KABUSHIKI KAISHA, Toyota-shi (JP)

(21) Appl. No.: 19/086,331

(22) Filed: Mar. 21, 2025

(30) Foreign Application Priority Data
Apr. 18, 2024 (JP) 2024-067507

(51) Int. Cl. H01M 50/249; B60L 50/64; H01M 50/202; H01M 50/271

(52) U.S. Cl. CPC H01M 50/249; B60L 50/64; H01M 50/202; H01M 50/271; H01M 2220/20

(57) ABSTRACT

Electricity storage apparatus includes: a stacked body mounted on a vehicle and formed by stacking an electricity storage module in the up-down direction; and a housing case that houses the stacked body. The housing case includes: a top plate positioned in a case upper surface of the housing case; a bottom plate positioned in a case lower surface of the housing case; a peripheral wall that connects the top plate and the bottom plate to each other; and a holding member. The stacked body includes: an upper surface; a lower surface; and a peripheral surface that connects the upper surface and the lower surface to each other. The holding member has: a holding rising wall; and a holding flange. The holding rising wall is formed so as to cover the peripheral surface. The holding flange is provided on the holding rising wall and is fixed to the peripheral wall.

### CROSS-REFERENCE TO RELATED APPLICATION

This application claims priority to Japanese Patent Application No. 2024-067507 filed on Apr. 18, 2024, incorporated herein by reference in its entirety.

### BACKGROUND

### 1. Technical Field

The present disclosure relates to an electricity storage apparatus.

### 2. Description of Related Art

For example, Japanese Unexamined Patent Application Publication No. 2024-007753 (JP 2024-007753 A) discloses a configuration of a side surface portion of a bipolar battery mounted in a vehicle lower portion.

### SUMMARY

The battery according to JP 2024-007753 A is weak against impact from surroundings, and hence there is room for improvement in terms of protecting the battery from impact from surroundings.

The present disclosure has been made in order to solve the problem described above, and an object thereof is to provide an electricity storage apparatus that is capable of reducing cases of being damaged by impact from surroundings.

An electricity storage apparatus according to a first aspect of the present disclosure is mounted on a vehicle. The electricity storage apparatus includes: a stacked body formed by stacking an electricity storage module in the up-down direction; and a housing case that houses the stacked body. In the electricity storage apparatus, the housing case includes: a top plate positioned in a case upper surface of the housing case; a bottom plate positioned in a case lower surface of the housing case; a peripheral wall that connects the top plate and the bottom plate to each other; and a holding member, the stacked body includes: an upper surface; a lower surface; and a peripheral surface that connects the upper surface and the lower surface to each other, the holding member has: a holding rising wall; and a holding flange, the holding rising wall is formed so as to cover the peripheral surface, and the holding flange is provided on the holding rising wall and is fixed to the peripheral wall.

The holding rising wall in the electricity storage apparatus according to the first aspect of the present disclosure includes a first side wall and a second side wall arranged in the width direction, and the holding flange is fixed to at least one of the first side wall and the second side wall.

The electricity storage apparatus according to the first aspect of the present disclosure is an electricity storage apparatus according to claim 1 or 2. The holding member in the electricity storage apparatus further has a covering member, and the covering member is provided so as to annularly extend from at least one end portion of the holding rising wall arranged in the up-down direction of the holding rising wall and cover an outer edge portion of the stacked body when the stacked body is seen in plan view from a position spaced apart from the stacked body in the up-down direction.

The covering member in the electricity storage apparatus according to the first aspect of the present disclosure includes an upper-end covering member connected to an upper end of the holding rising wall, and the upper-end covering member is caused to adhere to a part of the top plate that corresponds to the upper-end covering member in the up-down direction.

The holding member in the electricity storage apparatus according to the first aspect of the present disclosure is caused to adhere to the stacked body.

With the electricity storage apparatus according to the present disclosure, it is possible to reduce damage on the electricity storage apparatus even when impact from the surroundings is applied.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view showing a schematic configuration of an electricity storage apparatus according to an embodiment of the present disclosure;

FIG. 2 is a sectional view taken along II-II indicated in FIG. 1; and

FIG. 3 is a schematic perspective view of a stacked body and a holding member in the electricity storage apparatus of FIG. 1.

### DETAILED DESCRIPTION OF EMBODIMENTS

An embodiment of the present disclosure is described in detail below with reference to the drawings. The same or equivalent parts in the drawings are denoted by the same reference characters, and description thereof is not repeated.

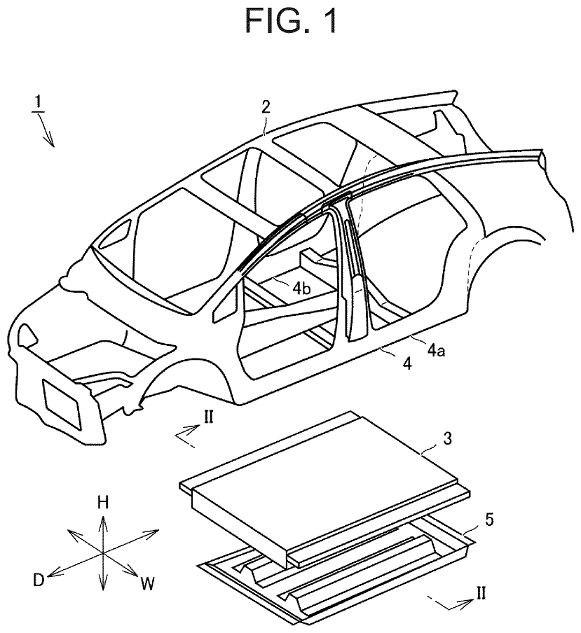

FIG. 1 is an exploded perspective view schematically showing a vehicle on which an electricity storage apparatus according to the present embodiment is mounted. Here, an up-down direction H shown in FIG. 1 indicates the up-down direction of the vehicle 1. A width direction W indicates the vehicle width direction of the vehicle 1. A front-rear direction D indicates the front-rear direction of the vehicle 1.

The vehicle 1 includes a vehicle body 2 and an electricity storage apparatus 3. The vehicle 1 includes a plug-in hybrid electric vehicle (PHEV), a battery electric vehicle (BEV), or a fuel cell electric vehicle (FCEV), for example.

The vehicle body 2 includes an underbody 4 and a share panel 5. The underbody 4 has a pair of side shells 4a, 4b arranged in the width direction W. The share panel 5 is disposed in a position facing the underbody 4 across the electricity storage apparatus 3 in the up-down direction H. The share panel 5 is also fixed to the underbody 4.

The electricity storage apparatus 3 is an apparatus for storing therein driving electricity of the vehicle 1, for example. The electricity storage apparatus 3 is fixed to the vehicle body 2 by being fastened to each of the pair of side shells 4a, 4b.

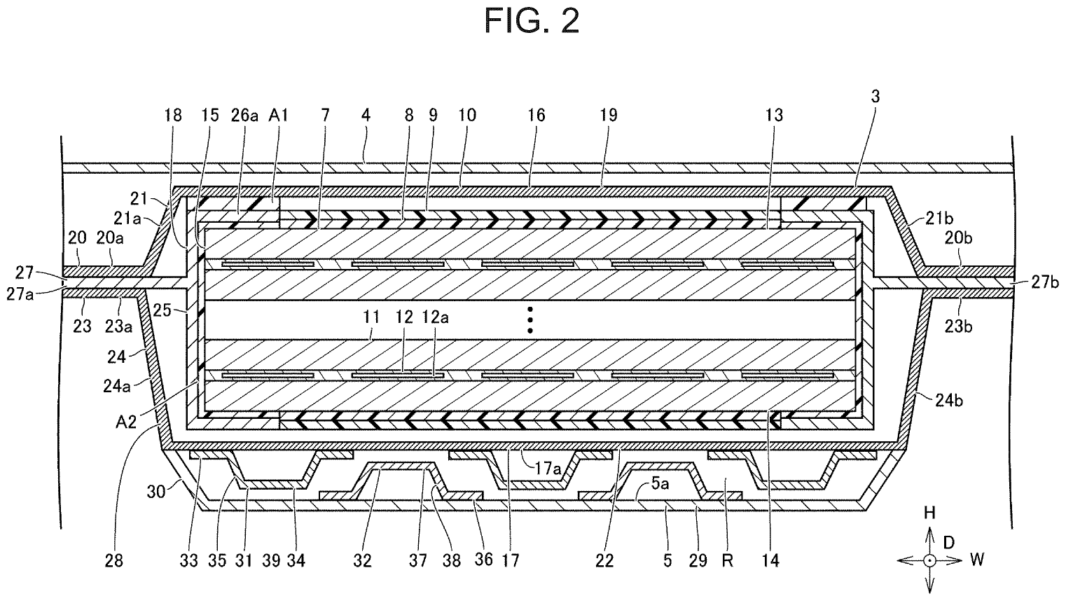

FIG. 2 is a sectional view taken along II-II indicated in FIG. 1. The electricity storage apparatus 3 has a stacked body 7, insulation sheets 8, elastic sheets 9, and a housing case 10.

The stacked body 7 is formed in a cuboid shape, for example. The stacked body 7 has an upper surface 13, a lower surface 14, and peripheral surfaces 15. The upper surface 13 and the lower surface 14 are surfaces arranged in the up-down direction H. The upper surface 13 is a surface positioned in the vicinity of the underbody 4 as compared to the lower surface 14. The peripheral surfaces 15 are surfaces that connect outer peripheral edge portions of the upper surface 13 and outer peripheral edge portions of the lower surface 14 to each other.

The stacked body 7 has electricity storage modules 11 and cooling apparatuses 12. The electricity storage module 11 is a bipolar battery, for example. The electricity storage module 11 is formed in a rectangular shape when the electricity storage module 11 is seen in plan view from a position spaced apart from the electricity storage module 11 in the up-down direction H. The electricity storage modules 11 are stacked in the up-down direction H such that the cooling apparatuses 12 are interposed therebetween.

The cooling apparatus 12 has electrical conductivity. Therefore, the cooling apparatus 12 electrically connects the electricity storage modules 11 adjacent to the cooling apparatus 12 in the up-down direction H to each other. The cooling apparatus 12 has flow passages 12a on the inside. A refrigerant flows through the flow passages 12a. As a result, the cooling apparatuses 12 can cool the electricity storage modules 11.

The insulation sheet 8 is formed by a material that has insulation property. The insulation sheet 8 is provided on each of the upper surface 13 and the lower surface 14 of the stacked body 7. The elastic sheet 9 is formed by an elastic body. The elastic sheet 9 is disposed on the insulation sheet 8.

The housing case 10 has an upper cover 16, a lower case 17, and a holding member 18.

The upper cover 16 is formed by a top plate 19, upper flanges 20, and hanging walls 21.

The top plate 19 is positioned in a case upper surface of the housing case 10. The top plate 19 is formed so as to cover the upper surface 13 of the stacked body 7. The top plate 19 is a member formed in a plate-like shape. The top plate 19 is formed in a rectangular shape when the top plate 19 is seen in plan view from a position spaced apart from the top plate 19 in the up-down direction H.

The upper flanges 20 are formed so as to extend in the width direction W. The top plate 19 and the upper flanges 20 are arranged to be spaced apart from each other in the up-down direction H. The upper flanges 20 include a first upper flange 20a and a second upper flange 20b. The first upper flange 20a and the second upper flange 20b are arranged to be spaced apart from each other in the width direction W across the stacked body 7. The first upper flange 20a and the second upper flange 20b are disposed on the same plane in the up-down direction H.

The hanging walls 21 connect the top plate 19 and the upper flanges 20 to each other. In more detail, the hanging walls 21 have a first hanging wall 21a and a second hanging wall 21b. The first hanging wall 21a and the second hanging wall 21b are arranged in the width direction W. The first hanging wall 21a connects one end of the top plate 19 arranged in the width direction W thereof and one end of the first upper flange 20a arranged in the width direction W thereof to each other. The second hanging wall 21b connects the other end of the top plate 19 arranged in the width direction W thereof and one end of the second upper flange 20b arranged in the width direction W thereof.

The lower case 17 is formed so as to be opened upward. The lower case 17 is formed by a bottom plate 22, lower flanges 23, and rising walls 24.

The bottom plate 22 is positioned in a case lower surface of the housing case 10. The bottom plate 22 is a member formed in a plate-like shape. The bottom plate 22 is formed in a shape having the same external form as the top plate 19 when the bottom plate 22 is seen in plan view from a position spaced apart from the bottom plate 22 in the up-down direction H. The bottom plate 22 is disposed so as to be spaced apart from the top plate 19 in the up-down direction H across the stacked body 7.

The lower flanges 23 are formed so as to extend in the width direction W. The top plate 19 and the lower flanges 23 are arranged to be spaced apart from each other in the up-down direction H. The lower flanges 23 have a first lower flange 23a and a second lower flange 23b. The first lower flange 23a and the second lower flange 23b are arranged to be spaced apart from each other in the width direction W across the stacked body 7. The first lower flange 23a and the second lower flange 23b are disposed on the same plane in the up-down direction H.

The rising walls 24 connect the bottom plate 22 and the lower flanges 23 to each other. In more detail, the rising walls 24 have a first rising wall 24a and a second rising wall 24b. The first rising wall 24a and the second rising wall 24b are arranged in the width direction W. The first rising wall 24a connects one end of the bottom plate 22 arranged in the width direction W thereof and one end of the first lower flange 23a arranged in the width direction W thereof to each other. The second rising wall 24b connects the other end of the bottom plate 22 arranged in the width direction W thereof and one end of the second lower flange 23b arranged in the width direction W thereof to each other.

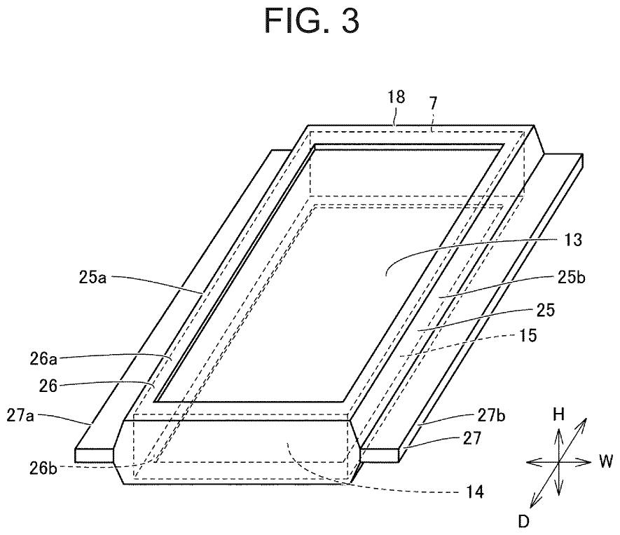

In FIG. 3, a schematic perspective view showing the stacked body and the holding member in the electricity storage apparatus of FIG. 1 is shown. The holding member 18 is formed by holding rising walls 25, covering members 26, and holding flanges 27.

The holding rising walls 25 are formed to annularly extend so as to cover the peripheral surfaces 15 of the stacked body 7. The holding rising walls 25 have a first side wall 25a and a second side wall 25b. The first side wall 25a is disposed on one end of the holding rising walls 25 arranged in the width direction W thereof and the second side wall 25b is disposed on the other end of the holding rising walls 25 arranged in the width direction W thereof.

The covering members 26 have an upper-end covering member 26a and a lower-end covering member 26b. The upper-end covering member 26a is annularly formed so as to cover outer edge portions of the upper surface 13 of the stacked body 7 and the vicinity thereof. The upper-end covering member 26a is connected to sections positioned on the upper side out of the end portions of the holding rising walls 25 arranged in the up-down direction H thereof.

The lower-end covering member 26b is annularly formed so as to cover outer edge portions of the lower surface 14 of the stacked body 7 and the vicinity thereof. The lower-end covering member 26b is connected to sections positioned on the lower side out of the end portions of the holding rising wall 25 arranged in the up-down direction H thereof.

The holding flanges 27 are formed so as to extend from the rising walls 24 in the width direction W. In more detail, the holding flanges 27 have a first holding flange 27a and a second holding flange 27b. The first holding flange 27a and the second holding flange 27b are disposed on the same plane in the up-down direction H. The first holding flange 27a is formed so as to extend from the first side wall 25a in the width direction W. The second holding flange 27b is formed so as to extend from the second side wall 25b in the width direction W.

With reference to FIG. 2 again, the upper-end covering member 26a is caused to adhere to the top plate 19 and a part of the top plate 19 that corresponds to the up-down direction H of the upper-end covering member 26a by a first adhesive A1.

The holding member 18 is caused to adhere to the stacked body 7 by a second adhesive A2. Specifically, the second adhesive A2 is applied to the peripheral surfaces 15 of the stacked body 7, regions corresponding to the upper-end covering member 26a out of outer edge portions of the upper surface 13 and its vicinity, regions corresponding to the lower-end covering member 26b out of outer edge portions of the lower surface 14 and its vicinity.

The housing case 10 is formed by the top plate 19, the bottom plate 22, and peripheral walls 28. The top plate 19 is positioned in the case upper surface of the housing case 10 in the up-down direction H. The bottom plate 22 is positioned in the case lower surface of the housing case 10 in the up-down direction H. The peripheral walls 28 are formed so as to connect the outer peripheral edge portions of the top plate 19 and outer peripheral edge portions of the bottom plate 22 to each other. The peripheral walls 28 are formed by the upper flanges 20, the hanging walls 21, the lower flanges 23, and the rising walls 24. The upper flanges 20 and the lower flanges 23 are fixed in the up-down direction H with the holding flanges 27 being interposed therebetween. In other words, the holding flanges 27 are fixed to the peripheral walls 28.

The first upper flange 20a, the first lower flange 23a, and the first holding flange 27a are fixed to the side shell 4a shown in FIG. 1. The second upper flange 20b, the second lower flange 23b, and the second holding flange 27b are fixed to the side shell 4b.

The share panel 5 is disposed below the lower case 17 of the electricity storage apparatus 3 in the up-down direction H. The share panel 5 is formed so as to be opened upward. A space R is formed between the share panel 5 and the lower case 17. The share panel 5 is formed by a steel plate. The share panel 5 has a main body portion 29 and a pair of connecting portions 30.

The pair of connecting portions 30 are disposed so as to be arranged to be spaced apart from each other in the width direction W. One end of each of the pair of connecting portions 30 is connected to each other by the main body portion 29. Each of the other ends of the pair of connecting portions 30 is joined to an outer peripheral edge portion of the bottom plate 22. As a result, the share panel 5 is fixed to the housing case 10.

First reinforcements 31 and second reinforcements 32 are disposed in the space R. The first reinforcements 31 are disposed in the space R and are fixed to a lower surface 17a of the lower case 17. The first reinforcements 31 are disposed by a plurality of numbers to be spaced apart from each other in the width direction W. Each of the first reinforcements 31 has a pair of joining portions 33, a main body portion 34, and connecting portions 35. The joining portions 33 are arranged to be spaced apart from each other in the width direction W. The main body portion 34 is disposed in a place between the pair of joining portions 33 and below the pair of joining portions 33. The connecting portions 35 connect each of the end portions of the pair of joining portions 33 to each of the outer peripheral end portions of the main body portion 34 arranged in the width direction W. The main body portion 34 and the connecting portions 35 are formed so as to protrude downward with respect to the joining portions 33. The joining portions 33 are fixed to the lower surface 17a of the lower case 17. As a result, the first reinforcement 31 is fixed to the lower case 17.

The second reinforcements 32 are disposed in the space R and are fixed to an upper surface 5a of the share panel 5. The plurality of second reinforcements 32 is disposed by a plurality of numbers to be spaced apart from each other in the width direction W. Each of the second reinforcements 32 has a pair of joining portions 36, a main body portion 37, and connecting portions 38. The joining portions 36 are arranged to be spaced apart from each other in the width direction W. The main body portion 37 is disposed in a place between the pair of joining portions 36 and above the pair of joining portions 36. The connecting portions 38 connect each of the end portions of the pair of joining portions 36 to each of the outer peripheral end portions of the main body portion 34 arranged in the width direction W. The main body portion 37 and the connecting portions 38 are formed so as to protrude upward with respect to the joining portions 36. The joining portion 36 is fixed to the upper surface 5a of the share panel 5. As a result, the second reinforcement 32 is fixed to the share panel 5.

Each of the second reinforcements 32 disposed in the space R is disposed between the first reinforcements 31. As a result, in the space R, the first reinforcement 31 and the second reinforcement 32 are disposed so as to be alternately arranged in the width direction W.

The stacked body 7 in the embodiment is bound by the holding member 18. The stacked body 7 is disposed in the housing case 10 to be spaced apart from the lower case 17 in the up-down direction H. By such a form, it becomes possible to easily carry the stacked body 7 by using the holding member 18 as a gripping portion. It becomes possible to reduce cases in which a load is transmitted to the stacked body 7 when impact from the lower side to the upper side in the up-down direction H is applied to the housing case 10.

The peripheral surface 15 of the stacked body 7 housed in the housing case 10 in the embodiment is protected by the holding member 18. By such a form, the impact applied to the vehicle 1 from the surroundings is transmitted to the stacked body 7 through the holding member 18. The holding member 18 is in contact with the stacked body 7 by surfaces. Therefore, it becomes possible to reduce cases in which a local load is applied to the stacked body 7 and reduce concentrated load onto the electricity storage module 11. It becomes possible to reduce cases in which the plurality of electricity storage modules 11 stacked in the up-down direction H slides in the width direction W. It becomes possible to reduce cases in which the electricity storage module 11 is damaged by impact from the surroundings.

The holding member 18 that binds the stacked body 7 housed in the housing case 10 in the embodiment is fixed to the peripheral walls 28. By such a form, it becomes possible to reduce cases in which an impact load is transmitted to the stacked body 7 as a result of fixing portions between the peripheral walls 28 and the holding member 18 coming off when impact is applied to the housing case 10 from the width direction W.

In the embodiment, the upper-end covering member 26a included in the holding member 18 is caused to adhere to the top plate 19 at a part of the top plate 19 that corresponds to the up-down direction of the upper-end covering member 26a by the first adhesive A1. By such a form, it becomes possible to transmit the load applied to the holding member 18 to the upper cover 16.

In the embodiment, the holding rising walls 25 are formed so as to annularly extend so as to cover all of the peripheral surfaces 15 of the stacked body 7, but the present disclosure is not limited thereto. For example, the holding rising walls 25 may be formed so as to cover only surfaces arranged in the width direction W out of the peripheral surfaces 15 of the stacked body 7. Specifically, the holding rising walls 25 may be formed by only the first side wall 25a and the second side wall 25b. Alternatively, the holding rising walls 25 may be formed so as to cover only surfaces formed to be parallel to the front-rear direction D out of the peripheral surfaces 15 of the stacked body 7.

In the embodiment, the holding member 18 has covering members 26, but the present disclosure is not limited thereto. For example, the holding member 18 does not necessarily need to have the covering members 26.

In the embodiment, the covering members 26 have the upper-end covering member 26a and the lower-end covering member 26b, but the present disclosure is not limited thereto. It is possible for the covering member 26 to have only either one of the upper-end covering member 26a or the lower-end covering member 26b.

In the embodiment, the holding flanges 27 has the first holding flange 27a and the second holding flange 27b, but the present disclosure is not limited thereto. For example, the holding flange 27 may have only either one of the first holding flange 27a or the second holding flange 27b. The holding flanges 27 may be formed so as to annularly extend from the holding rising walls 25.

It is to be understood that the embodiment disclosed above is merely an example in all aspects and in no way intended to limit the present disclosure. The scope of the present disclosure is defined by the scope of the claims, not by the embodiments described above. All modifications made within the scope and spirit equivalent to those of the claims are intended to be included in the present disclosure.

What is claimed is:

1. An electricity storage apparatus mounted on a vehicle, the electricity storage apparatus comprising:
a stacked body formed by stacking an electricity storage module in an up-down direction; and
a housing case that houses the stacked body, wherein:
the housing case includes:
a top plate positioned in a case upper surface of the housing case;
a bottom plate positioned in a case lower surface of the housing case;
a peripheral wall that connects the top plate and the bottom plate to each other; and
a holding member;
the stacked body includes:
an upper surface;
a lower surface; and
a peripheral surface that connects the upper surface and the lower surface to each other;
the holding member has:
a holding rising wall; and
a holding flange;
the holding rising wall is formed so as to cover the peripheral surface; and
the holding flange is provided on the holding rising wall and is fixed to the peripheral wall.

2. The electricity storage apparatus according to claim 1, wherein:
the holding rising wall includes a first side wall and a second side wall arranged in a width direction; and
the holding flange is fixed to at least one of the first side wall and the second side wall.

3. The electricity storage apparatus according to claim 1, wherein:
the holding member further has a covering member; and
the covering member is formed so as to annularly extend from at least one end portion of the holding rising wall arranged in the up-down direction of the holding rising wall and cover an outer edge portion of at least one of the upper surface and the lower surface of the stacked body.

4. The electricity storage apparatus according to claim 3, wherein:
the covering member includes an upper-end covering member connected to an upper end of the holding rising wall; and
the upper-end covering member is caused to adhere to a part of the top plate that corresponds to the upper-end covering member in the up-down direction.

5. The electricity storage apparatus according to claim 1, wherein the holding member is caused to adhere to the stacked body.
